(19) United States
(12) Patent Application Publication
(10) Pub. No.: US 2010/0100778 A1
(43) Pub. Date: Apr. 22, 2010

(54) SYSTEM AND METHOD FOR HARDWARE AND SOFTWARE MONITORING WITH INTEGRATED TROUBLESHOOTING

(75) Inventor: Francis Sullivan, Round Rock, TX (US)

Correspondence Address: HULSEY IP INTELLECTUAL PROPERTY LAWYERS, P.C., 919 Congress Avenue, Suite 919, AUSTIN, TX, 78701, US

(73) Assignee: SPICEWORKS, INC., Austin, TX (US)

(21) Appl. No.: 12/358,424

(22) Filed: Jan. 23, 2009

Related U.S. Application Data
(63) Continuation-in-part of application No. 12/117,533, filed on May 8, 2008.
(60) Provisional application No. 60/917,528, filed on May 11, 2007.

(51) Int. Cl. G06F 11/07; G06F 15/16

(52) U.S. Cl. 714/57; 709/224; 714/48; 714/E11.025; 714/E11.024

(57) ABSTRACT

A method, system, and network providing hardware and software inventorying, monitoring and support for a network of interconnected information technology devices. A user downloads and installs a local network monitoring software program from an online source onto a host computer system. The local network monitoring software system initiates an inventory of all information technology devices associated with said local network of information technology devices. Also, the local network monitoring software determines the operational status of the information technology devices and the status of software programs installed on the information technology devices. The results of the inventory and status determinations are presented to the host computer system. The presented information permits the user of said host computer system to initiate maintenance and support actions for the information technology devices in response to the operational status and status of software programs using the local network monitoring software.

### CROSS REFERENCE TO RELATED APPLICATIONS

This U.S. patent application is a continuation-in-part of pending U.S. patent application Ser. No. 12/117,533 filed May 8, 2008 entitled, “COMPUTER NETWORK SOFTWARE AND HARDWARE ASSET CONFIGURATION AND DISCOVERY SYSTEM AND METHOD” by inventor Francis Sullivan, which claims the benefit of priority of U.S. Provisional Patent Application No. 60/917,528, filed May 11, 2007, entitled, “COMPUTER NETWORK SOFTWARE AND HARDWARE WORKFLOW MONITORING AND REPORTING SYSTEM AND METHOD” by inventor Francis Sullivan, both of which are incorporated herein by reference in their entirety.

### FIELD

The present disclosure relates to methods and systems for managing an information technology (IT) network, and, more particularly, to computer network software and hardware event monitoring and reporting with an integrated resource acquisition system and method.

### BACKGROUND

Network management software has earned a reputation as being both costly to buy and complicated to set up and use. As a result, many smaller organizations tend to forgo it, filing it under “nice to have, but not worth the expense or hassle.” But, in putting off network management, a risk arises of letting a potential problem go unnoticed or even grow worse over time. Many smaller organizations typically do not have a dedicated IT staff member to upkeep all the computing systems being used by the business. Also, many owners or managers of small entities do not have the technical knowledge to be fully informed about new products and services. Certain technical issues such as hardware or software compatibility or expired software licenses can hurt productivity if problems go unattended. There exists a need to simplify the management of technological resources for a business network, including monitoring, reporting, and procurement of resources.

There is a need for an easy-to-use application that can inventory a network's systems and software (along with various other devices) and includes monitoring and reporting capabilities. Such a system should constitute a relatively small download that may be available via the Internet or other on-line source. The application should be able to run on either a current Microsoft Windows system such as Windows XP Professional, Window Vista Business, or Windows 2003 Server system, but it can manage all the common types of assets found in a business such as Windows 2000/XP, Mac OS X, Linux/Unix machines, printers, switches, routers, etc.

Such a network management system should use a minimum of documents and other complex instructions in its use. It should also avoid the need to install software agents on every system to provide control and query capabilities. Such a system should require the installation of software on only one system, to make configuring simple in most cases.

There is a need for such a system to provide displays within a simple browser-based interface, with default setting presenting an overview of a network organized by category. Such a display should show how many workstations, servers, printers and miscellaneous devices, as well as other network information operate on the network.

There is a need for a network management system that reports all of the Microsoft® software, services and operating system updates (or hot fixes) present on each of the systems it finds. Such a system should provide a rapid path to the software manufacturer for recognized applications. A further need exists for a system that allows sifting through a great deal of network information with a built-in report generator.

With such a network monitoring system, there is the need to stay in-step with the network by monitoring events within the network. The network monitoring system needs to provide in a desktop application a way to automatically identify PCs and servers with low disk space, the presence of unwanted software on the network, the status of your anti-virus updates, printers with low toner and ink levels, and offline servers.

When problems arise in a network, there is the need for the network monitoring system to aid the IT administrator to quickly identity the cause. Such a system should enable the IT administrator and other problem solvers to see what software is on a machine that is causing it to run slowly. Moreover, there is the need for such a system to be able to compare two or more machines to see what settings are different. Such a system should allow for quickly identifying the server that is running out of capacity. The desired IT network monitoring system would allow the user to easily see into an IT network to resolve problems more quickly.

Yet a further need exists for an IT network management system that includes for the users it serves a helpdesk function, deliver a single interface where an IT administrator may manage all daily tasks, projects and problems. There is a need for a system that may create a one-click ticket while browsing an IT network. Furthermore, such a system should allow the clients it serves to submit tickets via email or the Web and then view the status of those tickets online. Such a system should allow for assigning tickets across an IT team, attaching such tickets to hardware on the IT network, and managing projects relating to the network. Still further, there is a need for a system that can easily run reports on trouble solving tickets.

With such an IT management system, there exists a need to facilitate the replacement or repair of existing hardware or software resources that are found to be deficient from a system scan. The management system should have an integrated resource acquisition ability to provide relevant links to the manufacturer or producer of the deficient resource and should suggest similar items for comparison.

### BRIEF DESCRIPTIONS OF THE DRAWINGS

The accompanying drawings, which are incorporated in and constitute a part of this specification, illustrate several embodiments of the disclosure and together with the description, serve to explain the principles of the disclosure.

For a more complete understanding of the present embodiment, and the advantages thereof, reference is now made to the following brief descriptions, which are to be taken in conjunction with the accompanying FIGUREs, in which like reference numerals indicate like features.

FIG. 1 shows a high level schematic architecture of the present disclosure;

FIG. 2 shows how the presently disclosed network management system allows an IT administrator to browse an IT network and see network content, while IT equipment and software vendors obtain targeting opportunities for potential purchasers;

FIG. 3 depicts how the process of the present disclosure promotes purchase opportunities for buyers and sellers in an IT network environment;

FIG. 4 depicts a general purpose computer environment for implementation of the present disclosure;

FIG. 5 shows how the presently disclosed system supports the activities of an IT network administrator;

FIG. 6 depicts the actions and interface of the present IT network management system for inventorying the computers and other assets of an IT network;

FIG. 7 shows an inventory of software applications residing a selected computer workstation of an IT network as provided by the disclosed subject matter;

FIG. 8 shows the user interface for a robust set of community communication resources and communication platforms provided the disclosed IT network management system;

FIGS. 9 through 11 depict alert context operations of the disclosed IT network management system, including a set of helpdesk functions for the presentation of a work ticket and related information;

FIG. 12 presents a network environment report as provided by the presently disclosed system;

FIGS. 13 through 16 present a detailed comprehensive report for a computer workstation monitored by an IT network as provided by the presently disclosed subject matter;

FIGS. 17 and 18 show, respectively, a list of reports and an exemplary fixed asset report that the system of the presently disclosed subject matter may provide to an IT administrator.

FIG. 19 presents a flow diagram for the asset and configuration discovery features of the presently disclosed IT network management system; and

FIG. 20 presents a flow diagram for a watcher flow functions of the present disclosure.

### DESCRIPTION OF PRESENT DISCLOSURE

Having described briefly the above-listed FIGUREs showing the different functions and interfaces of the presently disclosed system, what follows enables a reader having ordinary skill in this art to make and use the claimed subject matter. The present disclosure, therefore, includes an architecture for interfacing a user community and advertisers/vendors in understanding, monitoring, improving, troubleshooting, and applying IT resources to an enterprise. For purposes of the present disclosure, an enterprise may be a company or organization associated through at least one local area network to which computers, peripherals, and other information technology assets and users of such assets may associate. Providing an integrated information sources platform, the presently disclosed system presents contextual views and access for the benefit of both a user community and product and service advertisers according to their differing and particular needs.

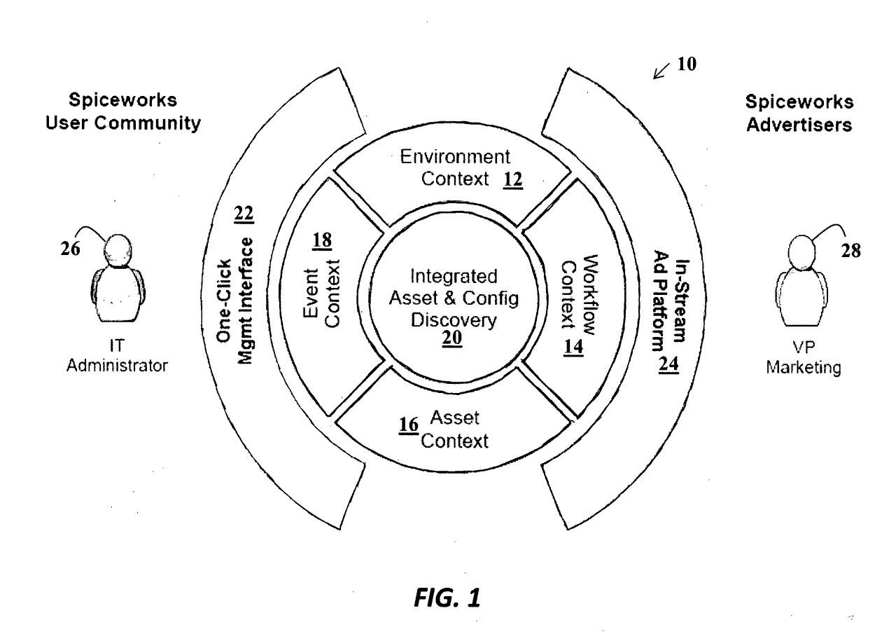

FIG. 1 provides a high-level architectural view of disclosed IT network management system 10. IT management system 10 provides enhanced and efficient management capabilities to IT administrators 26, while also providing in-stream targeting advertising opportunities to advertisers 28. IT management system 10 includes environment context 12, workflow context 14, asset context 16, and event context 18. Integrated asset and configuration discovery system 20 discovers assets on the network and provides this information to various contexts 12, 14, 16, and 18. IT administrators 26 may view and manage their networks through one-click management interface 22. Advertisers 28 may produce targeting advertising opportunities through in-stream ad platform 24.

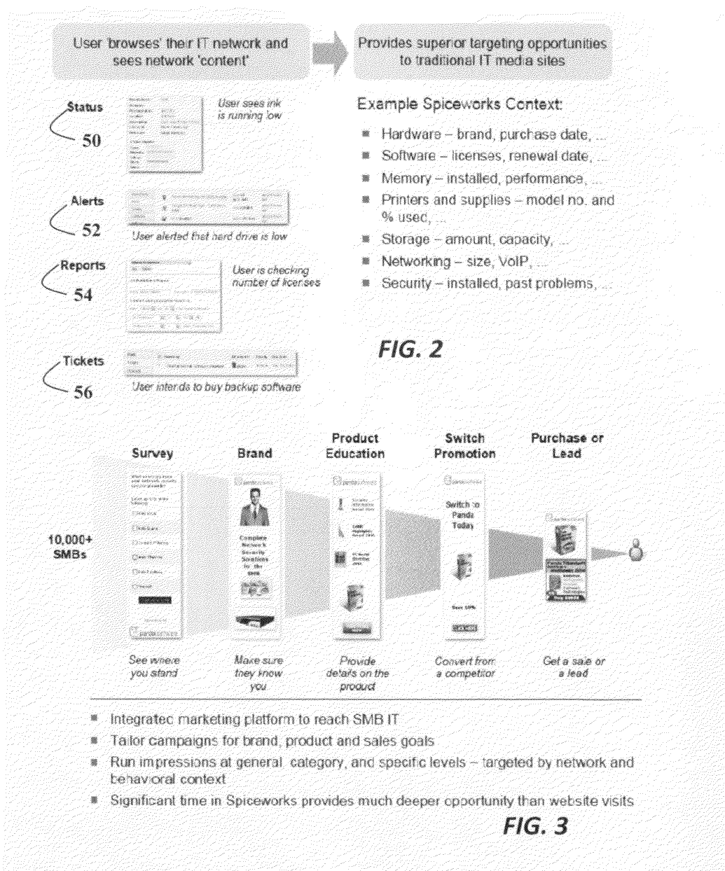

FIG. 2 shows how the disclosed subject matter allows an IT administrator to browse a network for network content, while IT equipment and software vendors obtain targeting opportunities for potential purchasers. Integrated asset and configuration discovery system 20 of FIG. 1 scans the network and provides information relating to the system and its components, such as type of computer, operating system, and other information. Additionally, the present system provides the user with system status 50 (such as low ink), system alerts 52, reports 54 on the problem (such as number of licenses), and work order or purchase order tickets 56 may be created and assigned. A work order ticket allows a user to submit problems associated with the asset to an IT administrator. A purchase order ticket allows the purchase needs of a user to be sent to an IT administrator.

FIG. 3 depicts process 100 for promoting purchase opportunities for buyers and sellers in an IT network environment. For the advertiser/vendor community, the disclosed subject matter provides in-stream advertising platform 24 of FIG. 1 that tailors advertisements and product information to the particular needs of an enterprise network through survey 102, brand 104, product education 106, and switch promotion 108 steps. The disclosed subject matter allows for confidentiality and security within any network. Advertisements provide the user with options to purchase necessary components, such as software, memory or disk drives, represented by the brands and purchase or lead steps. Advertisement revenue allows the software to be distributed for free or at a reduced cost to the end user. The system and process of the present disclosure accommodates highly stringent needs for confidentiality and security within any network wherein the system and methods are applied.

The different contexts supporting the IT network management system 10 and method include environmental context 12, asset context 14, workflow context 16, and event context 18 all associating with a view of the integrated information sources (FIG. 1). The different contexts also associate with one-click management interface 22 for the benefit of user community 26.

Environment context 12 engine provides the host server the ability to review meta-data with respect to all members of the community, such as what type of business, how many computer, servers or users at the target site. An aspect of this embodiment of the present disclosure is capable of also providing an individual member of the community meta-data on other users, but without any proprietary or confidential data being accessible.

Workflow context 14 engine is a smart engine providing the user with information based on the processes that user is currently running. Workflow context 14 engine facilitates the acquisition of resources by presenting relevant information and advertising links to the user during the use of the management program. For instance, if an end of year inventory program is running workflow context 14 engine may direct the user to websites where identified or needed computer or network hardware, software or peripherals may be researched and purchased. Additionally, the workflow context 14 engine may simply drive advertisements to the user relating to the user's perceived needs.

Asset context 16 engine provides the user with the ability to view the network assets on an individual, group or global basis and generate reports, flags and alerts regarding aspects of the system monitored by an aspect of the present disclosure.

Event context 18 engine provides the user with insight in to the system, such as access to critical or proprietary information, monitoring web-server activity as a security measure or general activity of personnel after business hours.

Integrated asset and configuration discovery system 20, in the form of software, subroutine, or engine, scans the network and provides information relating to the system and its constitute components, such as type of computer, operating system etc. Additionally, the present system provides the user with system status 50, alerts 52, reports 54, and work order or purchase order tickets 56 (FIG. 2). Advertisers may be integrated in to the system through advertisements to provide the user with an option to purchase necessary components, such as software, memory or disk drives (FIG. 3).

User community 26 aspect of the present disclosure provides to the user the ability to consult other users who are similarly situated, so that the user may review configurations and setups and also ask questions and obtain help from other users who may experience some of the same concerns, issues or problems.

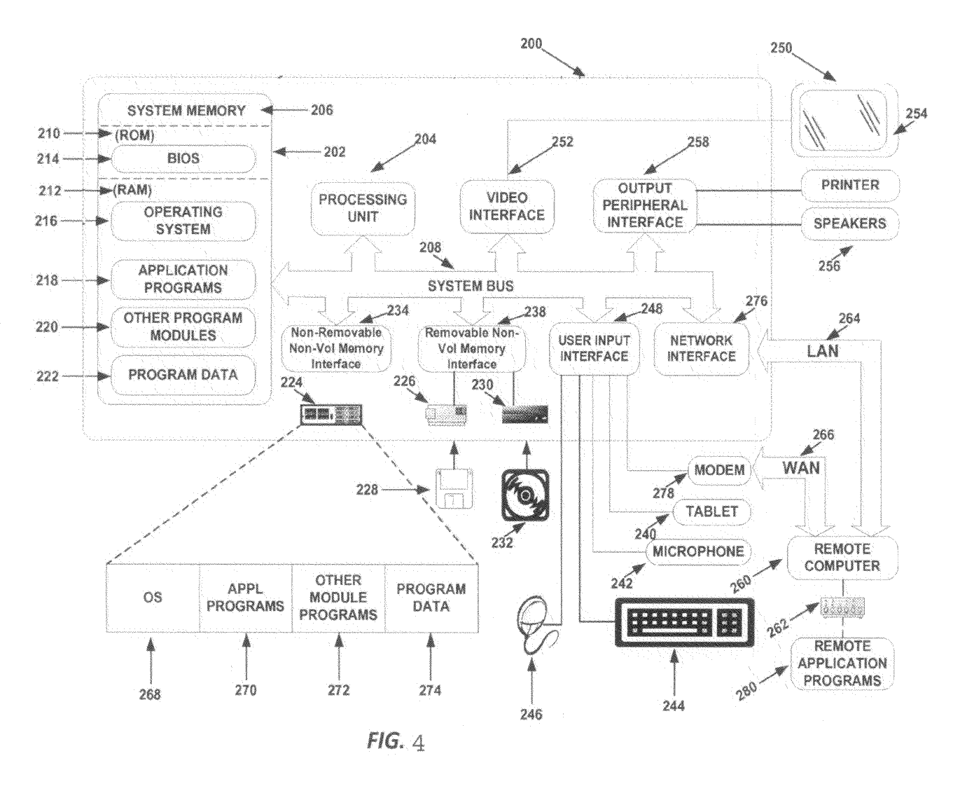

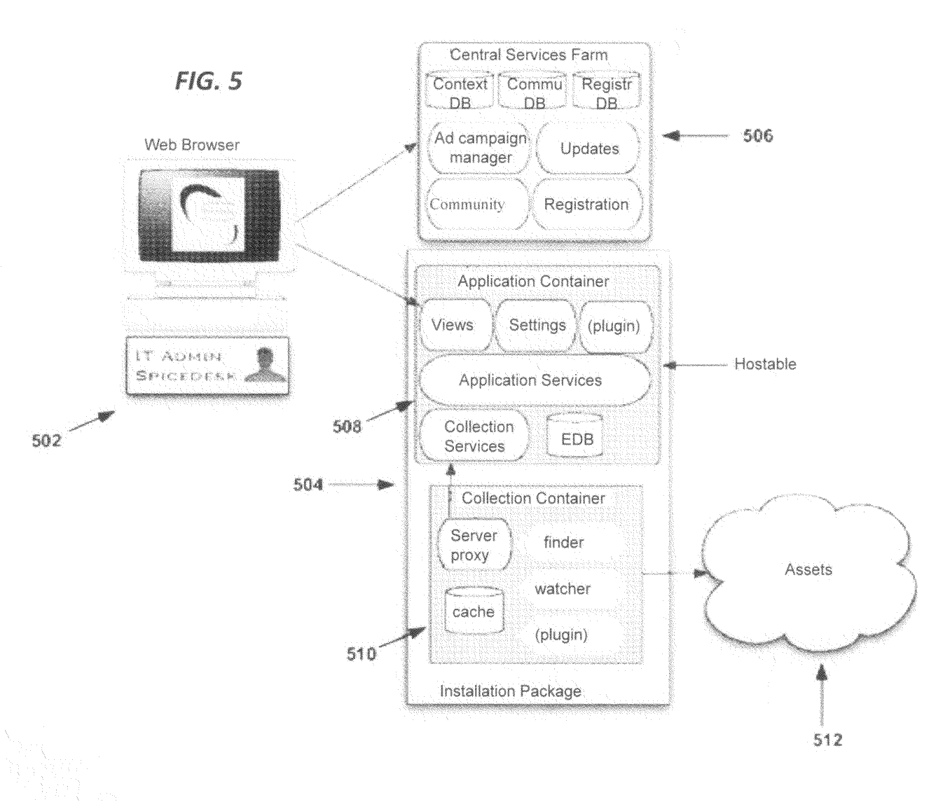

FIG. 4 provides an overview of computer hardware and a suitable computing environment in conjunction with which one or more embodiments of the present disclosure may be implemented. Embodiments are described in terms of a computer executing computer-executable instructions. However, some embodiments may be implemented entirely in computer hardware in which the computer-executable instructions are implemented in read-only memory. Some embodiments may also be implemented in client/server computing environments where remote devices that perform tasks are linked through a communications network. Program modules may be located in both local and remote memory storage devices in a distributed computing environment.

In FIG. 4, a computing system 200 is only one example of a suitable computing environment and is not intended to suggest any limitation as to the scope of use or functionality of the disclosure. Neither should the computing system 200 be interpreted as having any dependency or requirement relating to any one or combination of components illustrated in the exemplary operating computing system 200.

With reference to FIG. 4, an exemplary system within a computing environment for implementing the disclosure includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 208 that couples various system components including the system memory to the processing unit 204. The system bus 208 may be any of several types of bus structures including a memory bus or memory controller, a peripheral bus, and a local bus using any of a variety of bus architectures.

Computing system 200 typically includes a variety of computer readable media. Computer readable media may be any available media that may be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, FIG. 4 illustrates operating system 216, application programs 218, other program modules 220 and program data 222.

Computing system 200 may also include other removable/non-removable, volatile/nonvolatile computer storage media. By way of example only, FIG. 4 illustrates a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 208 through a non-removable memory interface such as interface 234, and magnetic disk drive 226 and optical disk drive 230 are typically connected to the system bus 208 by a removable memory interface, such as interface 238.

The drives and their associated computer storage media, discussed above and illustrated in FIG. 4, provide storage of computer readable instructions, data structures, program modules and other data for the computing system 200. In FIG. 4, for example, hard disk drive 224 is illustrated as storing operating system 268, application programs 270, other program modules 272 and program data 274. Note that these components may either be the same as or different from operating system 216, application programs 218, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel may be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated in FIG. 4. The logical connections depicted in FIG. 4 include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being migrated, and the remote computing system 260 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present disclosure. The operating system or systems may reside at a central location or distributed locations (i.e., mirrored or stand-alone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor may read information from, and write information to, the storage medium. In the alternative, the storage medium may be integral to the processor. The processor and the storage medium may also reside in an ASIC. The bus may be an optical or conventional bus operating pursuant to various protocols that are well known in the art.

FIG. 5 depicts a user interface 502, typically manned by the IT administrator of the network. Software module 504 is typically installed on a network to provide the functionality offered by the aspects of the present disclosure. Software engine 506 is typically hosted off-site from the user and gathers information from multiple users. Software engine 506 is also responsible for providing relevant advertisements to the user interface. Although in a far-flung world-wide organization, engine 506 may be implemented by a third-party for the benefit of the organization or by the IT department of the organization. The application engine 508 contains subroutines that provide the user with such functionality as views, setting, application services, collection of services and a host of other services. This list is meant to be exemplary and not limiting in any manner.

The collection engine 510 provides the user with server proxy, finder, watcher and third party functionality as aspects of the present disclosure. Engines 508 and 510 may be employed jointly in a network or separately. In a typical installation, engine 510 will be installed at multiple sites in a distributed network 512 or in a network that has several fire-walls or security measures, downstream of them and then to provide retrieved information to the application engine 508. Although an IT administrator may change these settings, typically the application dynamically figures out the appropriate IP addresses, domain name, etc. required to gather the information from or to which it should transmit the acquired data.

A particularly advantageous aspect of the presently disclosed method and system is the ability to keep information technology (“IT”) simple with a set of easy-to-use functions and information relating to their use through a readily-understandable interface. The presently disclosed method and system substantially frees an IT administrator from the day-to-day complexity of network use. The present disclosure provides the ability to inventory and monitor an entire network, operate an IT helpdesk for the enterprise, troubleshoot the local network, report on network assets and performance, as well as provide the user with the ability to obtain desired products for the network and its components (e.g., computer software, printing supplies), all through a simple one-click management interface.

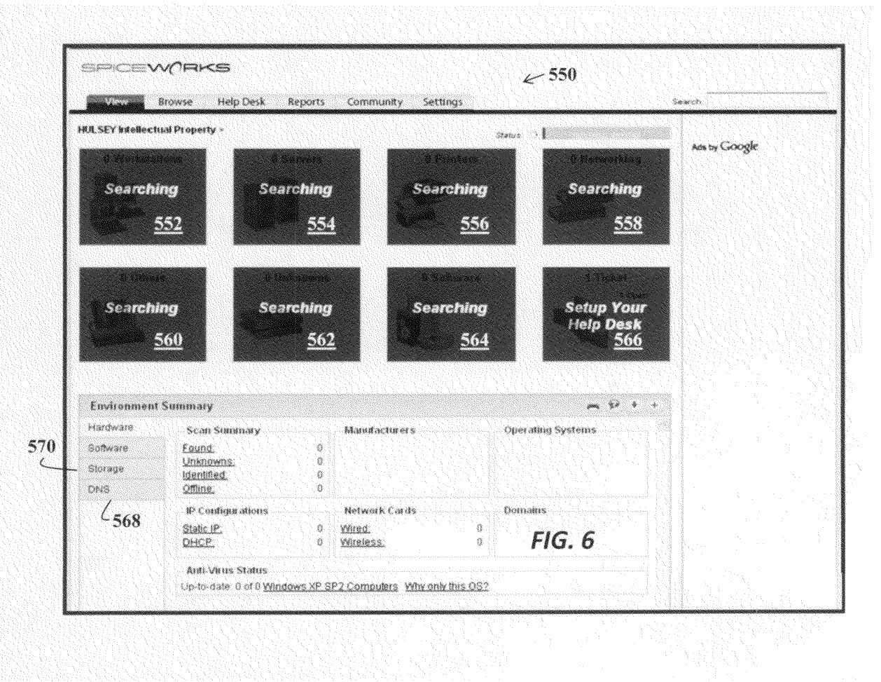

FIG. 6 shows user interface 550 for accessing inventory functions of the present disclosure. Inventory functions include the ability to determine what hardware and software a network includes. This includes inventorying all the Windows, Mac, and Linux PCs 552 and servers 554, routers 558, printers 556 and any other IP-based devices 560 on a network. Unknown devices 562 or devices for which no information can be given, but which the present system still detects, may also be shown. The present disclosure supports discovering software 564 installed on the network. Software 564 on the network may include, but is not limited to, packages, services, hot fixes, and patches. Settings for helpdesk 566 may also be specified. This includes the function of readily accessing service tags, which may be especially helpful when a need exists to contact a personal computer or other product manufacturer for support.

The IT administrator may use the presently provided DNS tab 568 to see how all DNS mapping is setup within the network. DNS tab 568 helps in identifying missing pieces and avoiding issues slowing down a network. The IT administrator may browse the network by MAC address to quickly identify devices that do not belong and eliminate unauthorized devices from the network. In addition, the IT administrator may click on storage tab 570 to see which disk drives are full and which are empty, thereby avoiding performance or application problems.

With the present method and system, there is the ability to acquire the MAC addresses for the computers on a network in order to easily sort out all network cables and ports. Moreover, the present disclosure teaches how to define and track custom attributes such as warranty, expiry date, purchase price, and more.

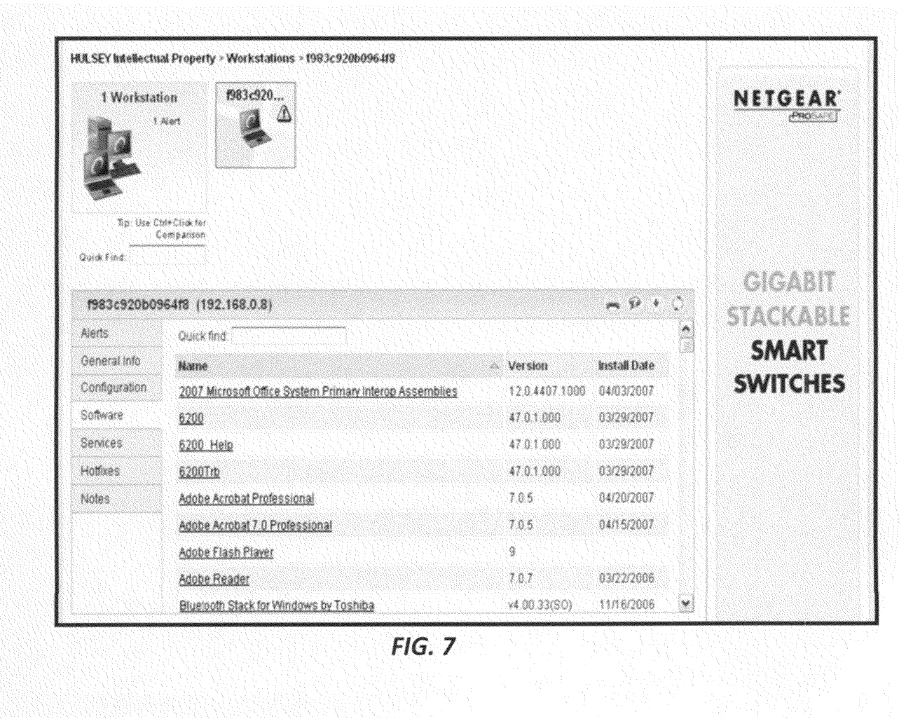

FIG. 7 shows notes tab 580 of the present disclosure. The present disclosure further enables tracking manual assets such as monitors, projectors, cell phones, or other assets, as desired, as well as to “tag” assets by entering searchable, free-form notes directly into the present system on any asset in the system. The present disclosure provides the ability to automatically inventory hardware and software on the network multiple times a day. Further, the present disclosure enables IT administrators to stay on top of software compliance by knowing how many software licenses they've purchased relative to how many they are using.

The present method and system facilitate monitoring a network to determine what is working, not working, and what needs attention. Using the present system permits being proactively alerted to low hard drive capacity, low printer ink and toner, or servers that are offline. These alerts can be altered to whatever capacity limits the IT administrator desires, such as when a hard drive reaches 80% capacity or if the antivirus software subscription will expire within 2 weeks. Moreover, the IT administrator may be notified when users install unauthorized software or un-install critical software. The present system allows for entering the number of licenses a network should have for a software package and will notify the IT administrator when the network exceeds the license allotment. Doing so ensures that the network stays compliant with the allowed licenses. The IT administrator will know when someone creates a Windows user account, thus avoiding the use of phantom network accounts.

The present disclosure also presents a time and cost efficient method of procuring resources. The management resource monitoring generates a report once user pre-set parameters are met regarding various system resources, such as, but not limited to, RAM usage, printer ink supply, printing supply usage, or disk drive capacity. A resource ticket containing the device name and location, manufacturer, and the present capacity of the resource is then sent to the IT manager regarding the identified source. Based on the generated resource ticket, the present disclosure provides the user with the ability to order the resource directly from the web. The present disclosure may direct an IT administrator to the original manufacturer, based on data garnered from the device, or an alternate source.

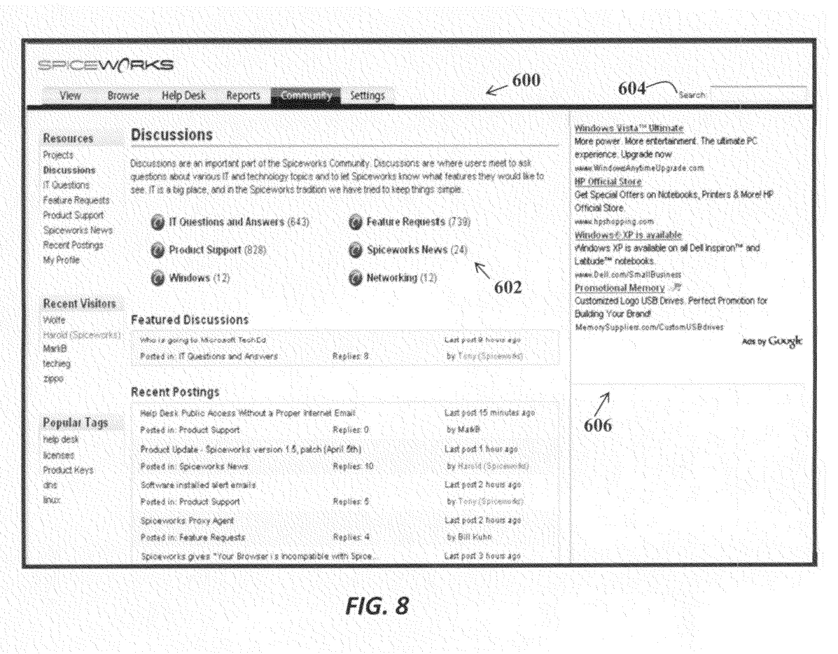

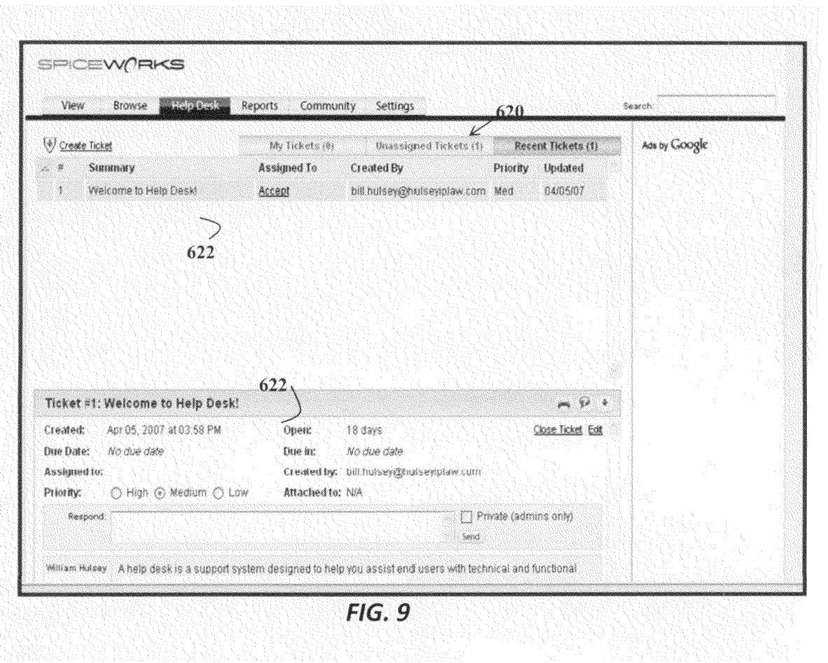

FIG. 8 shows user community tab 600 of the present disclosure. Using discussions area 602, the disclosed system allows the user to browse the community questions and answers to learn from other small to medium business IT administrators, to obtain useful info from trusted technology vendors about the IT products and services they needs most, including storage solutions, VoIP and much more. Through search bar 604, an IT administrator may launch a Google®-type search directly from the present system to obtain desired technical information. Having direct access to the network avoids the need to hop across browser tabs. In addition, the IT administrator may link directly to a vendor's support site for a desired product or patch.

Further, the community forum enabled by user community tab 602 permits users to interact with other IT administrators regarding IT products and services. The feedback section allows users to rate a product and give comments regarding its performance. This benefits the user, because they can see what other IT administrators recommend as a system resource. Another advantage of the community feedback forum is that it allows vendors/advertisers to make improvements to their products based on the feedback provided through the forums.

The present disclosure employs an in-stream commerce platform 606 on a portion of the general user interface. This platform may be an RSS or Atom feed provided by Google® Adsense or similar advertising service. The present disclosure gathers proprietary data about the user and their environment but does not include any user identifiable content, providing a confidential but highly specific targeting advertising opportunity for distributors of hardware and software resources. This benefits both the user and the vendor/advertising community because the user receives information regarding new products or upgrades that may be critical to their network operation and the vendors/advertisers can specifically send advertisements to users of their products, lowering advertising costs.

Still a further feature of the present system includes the ability to obtain information regarding needed IT products. For example, an IT administrator may submit a feature request to the disclosed system in the feedback section of the system's forums. A sort feature allows sorting requests by popularity to see what other IT administrators have desired in their implementations of the disclosed system. Furthermore, through the disclosed system an IT administrator may be a product advisor and help build the community of user tools for other IT administrators.

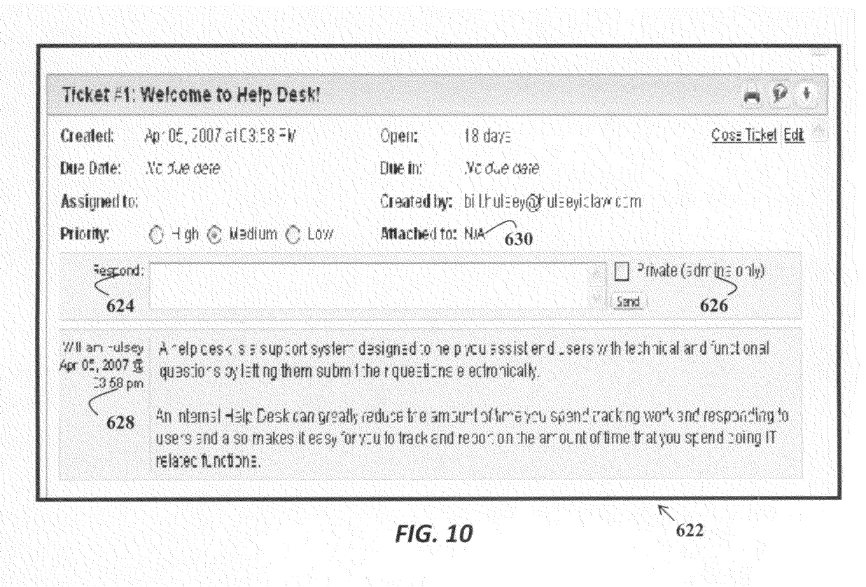

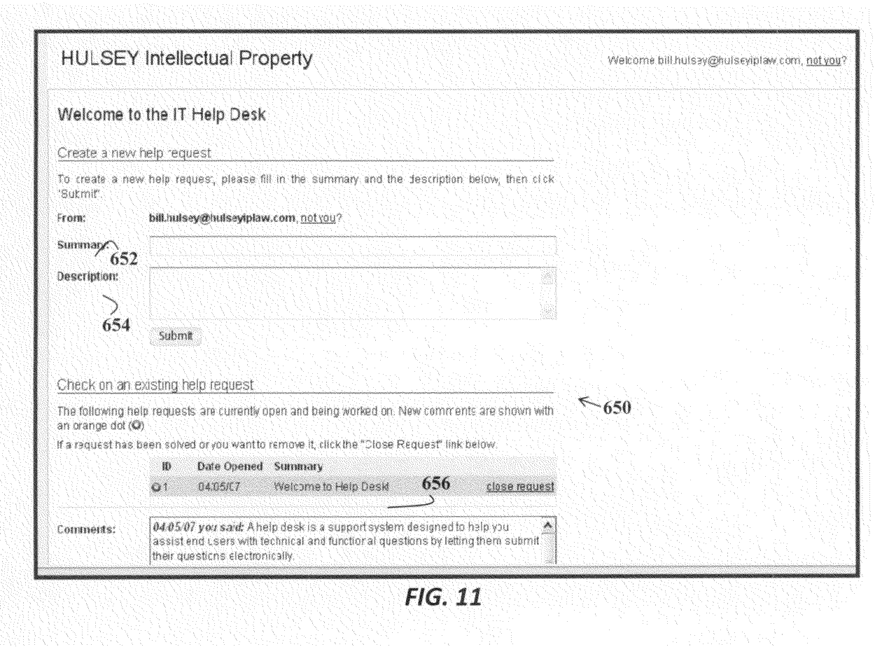

FIGS. 9, 10, and 11 provide user interfaces for exposing different aspects of the helpdesk function of the present disclosure. In FIG. 9, helpdesk tab 620 enables users to view tickets 622. FIG. 10 shows another view of ticket 622. Ticket 622 to includes area 624 for responding to the problem; area 626 for designating privacy settings; area 628 for viewing the problem; and area 630 for designating the problem hardware or software. FIG. 11 shows user interface 650 for creating a ticket. A user may include description 654 and summary of the problem 652. Further, a user may view status 656 of an existing ticket.

By generating and providing a system for keeping track of tickets 622, projects, and problems for each computer, the present system greatly facilitates problem solving. The present system allows a user to create tickets 622 by submitting issues via e-mail or a web portal. The ticket may also be submitted to the host computer through other acceptable electronic media. The system may automatically send notifications to an IT administrator on the status of devices such as low ink, too many licenses on the network, etc. These notifications may be administrator created.

Furthermore, the present method and system enable users to view the latest status 656 of tickets 622 via the helpdesk web site. Using the disclosed subject matter, an IT administrator may respond to users via a desktop interface and, in association with the response, notify the user with an email reflecting the work performed or problem solved.

The present system allows for adding private comments to a ticket that are not visible to a user, further allowing an IT administrator to document all activity related to that ticket. The IT administrator may create tickets while looking at any asset on the enterprise network, automatically “attaching” that ticket to the asset and aggregating it with any information that currently exists on the asset. Furthermore, the IT administrator may track projects with tickets and sort “To Do's” by due date and priority. The presently disclosed system allows the IT administrator to run a report on all tickets, thereby enabling a view of which hardware or software (or department!) causes the IT administrator the most problems.

Another workflow context and event context set of features of the presently disclosed system and method include providing an integrated helpdesk set of features. The present system application includes an integrated helpdesk that the IT administrator may use to track work they are doing for themselves or others. Just like the rest of the system, the tickets in this helpdesk are automatically associated with the relevant hardware or software assets so that needed information is always at hand. The integrated helpdesk includes end user email notification if action is taken on a ticket, an integrated end user helpdesk web interface.

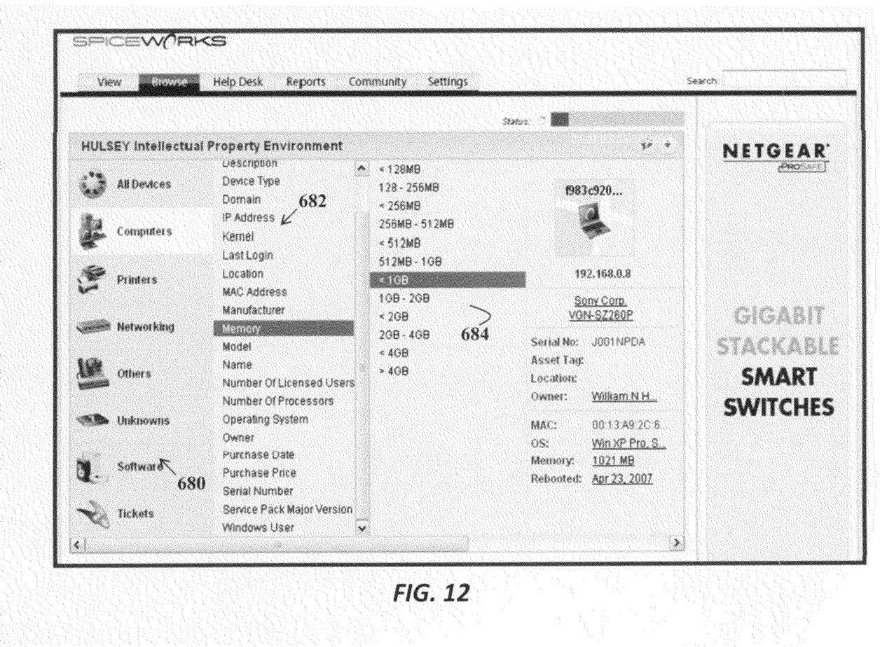

FIG. 12 shows aspects of the present system which enable enhanced troubleshooting capabilities. An IT administrator may view different hardware and software on the network through tab 680. Through tab 682, the administrator may then sort the selected device type by various criteria. For example, as shown in FIG. 12, an IT administrator may select computers through tab 682 and then view the computers having memory range 684.

Troubleshooting an enterprise network is significantly enhanced by the method and system here disclosed. The IT administrator may readily determine why a computer, peripheral, or other component is not operating properly and, in response to the information the present system provides, determine the appropriate remedial steps. For example, the present system provides the ability to compare the configuration of two computers, thereby allowing the identification of differences between the machines, including hardware, software, patches, etc.

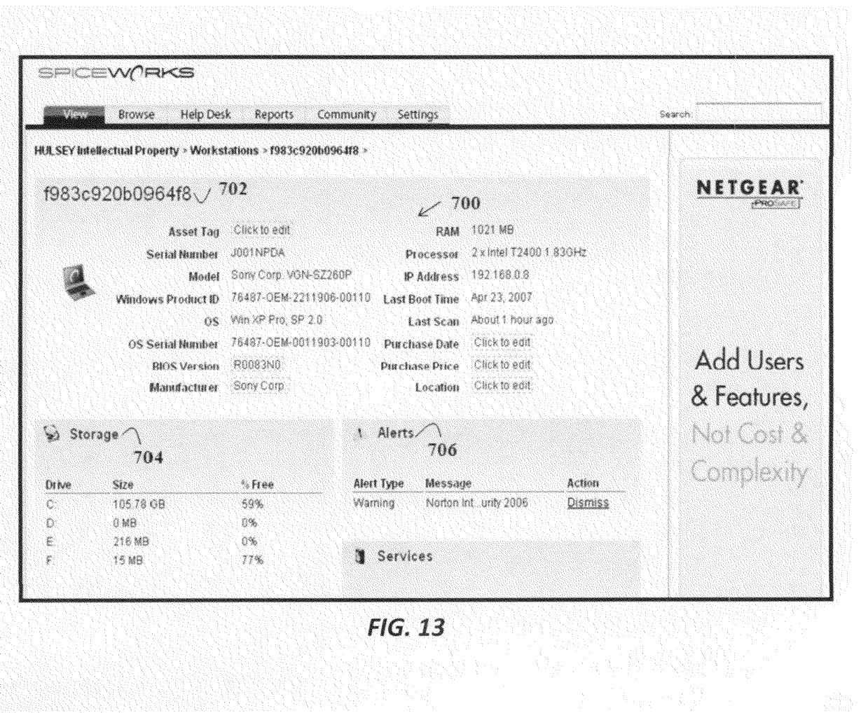

FIGS. 13 through 16 show software and hardware information 700 that may be viewable through the system and method of the present disclosure. The list presented is only meant to be a partial listing of the information that may be viewable. In fact, IT administrators may add their own fields such as region to the specified hardware or software.

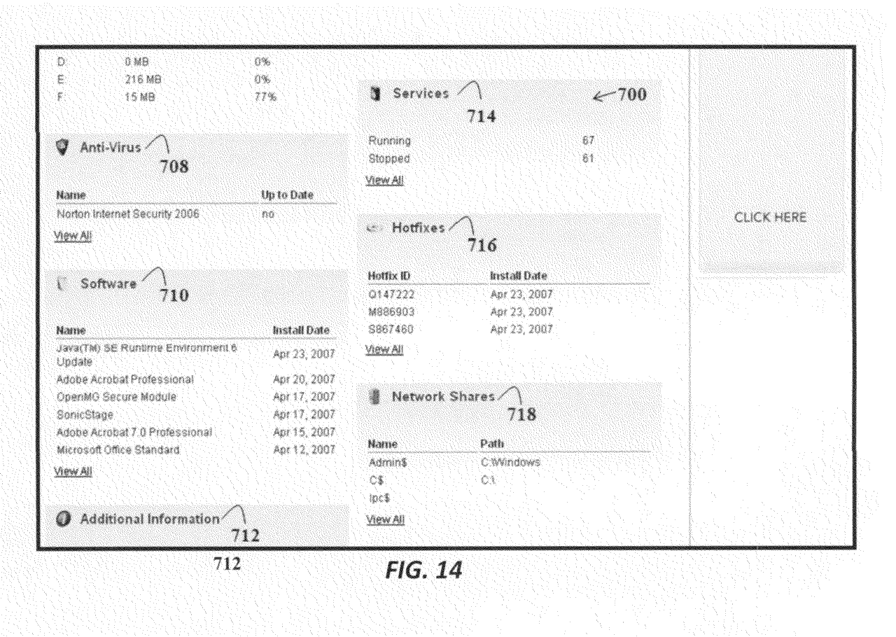

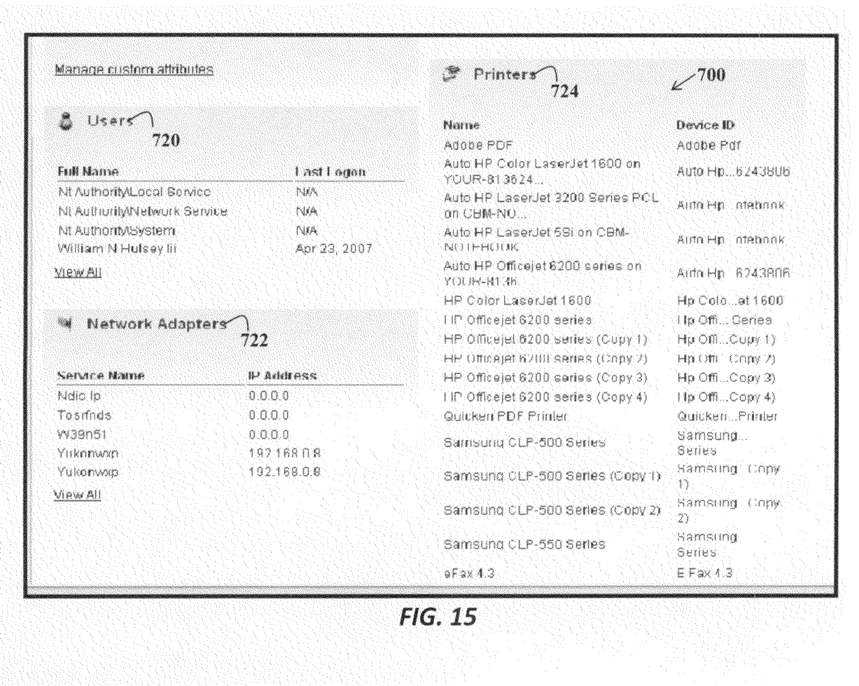

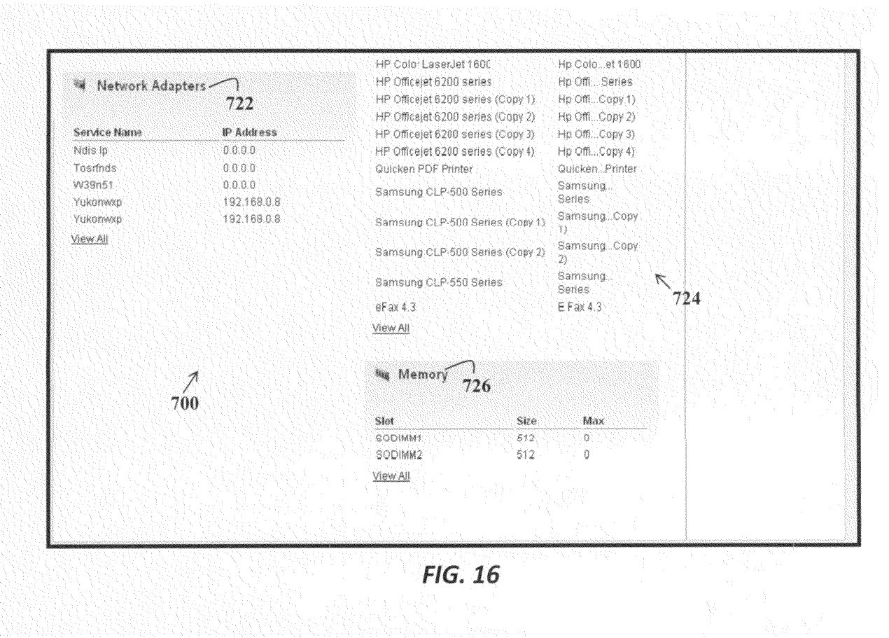

FIG. 13 shows device information 700 that may be viewable through the method and system of the present disclosure. Tab 702 displays general information for the asset. The amount of storage left on workstations or other hardware may be viewable through tab 704. Tab 706 shows alerts for device 702. FIG. 14 shows additional device information 700. IT administrators may view anti-virus software 708, software 710, additional information 712, services 714, hot-fixes 716, and network shares 718. FIG. 15 shows additional information 700 such as user accounts 720 on the device, network adapters 722 such as routers connected to the device, and printers 724 connected to the device. FIG. 16 shows additional information 700 such as memory 726.

The IT administrator may click on a software tab within the present system to see a list of applications, services and hot-fixes installed in the enterprise network over the last day, week or month (FIGS. 13 through 16). This will significantly prevent unauthorized software from being loaded into the network.

Using the present system, an IT administrator may check to determine whether users have disabled their anti-virus software and ensure anti-virus packages are enabled and up-to-date. Moreover, the system and method of the present disclosure allow for providing the latest support information on hardware and software by using the built-in links to vendors support sites.

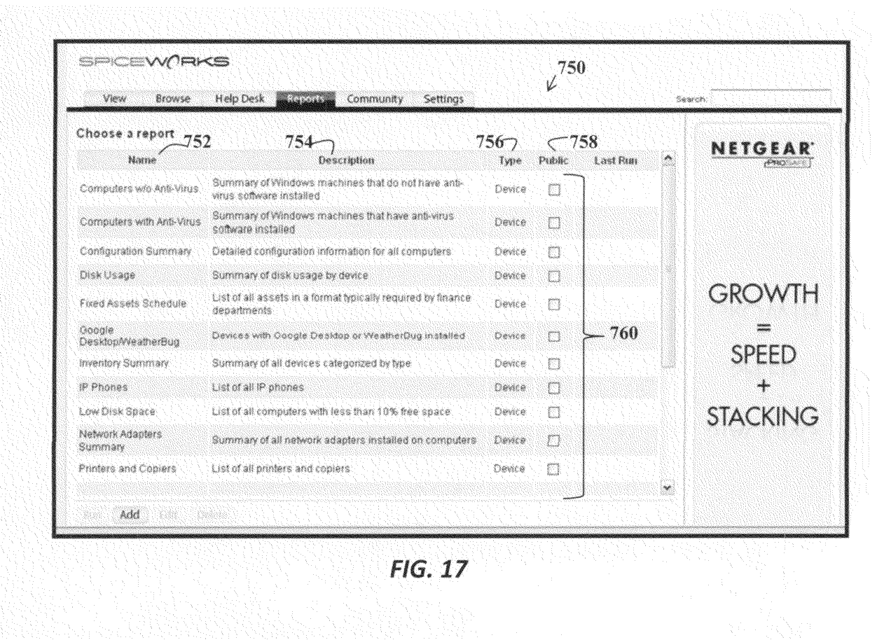

Another aspect of the present disclosure is the ability to generate a variety of reports on the status of an enterprise network. FIG. 17 shows one possible user interface 750 for viewing reports 760 for hardware and software on the network. User interface 750 shows the name 752 of the report, a description 754 of the report, the type 756 of report, and privacy settings 758. Reports 760 may include what information the IT administrator needs to reviews or share with others in the enterprise. Reports 760 may include network summary reports and reports that may be exported to PDF or Excel for printing, as well as other analyses.

The present system includes many useful initial reports 760 that work with zero additional configurations needed by the IT administrator. These reports may be augmented or adjusted if the IT administrator desires. For a given report, the IT administrator may view, print, or export the report date for use outside of the present system. The currently supported exported formats are .pdf, .csv, and .xcl.

As shown in FIG. 17, initial reports 760 may include (a) inventory summary; (b) detailed inventory; (c) fixed assets schedule; (d) computers without anti-virus software; (e) computers with anti-virus software; (f) assets that have software running that is not allowed (g) inventory of IP phones; (h) inventory and usage of printers; (h) open Helpdesk tickets; (i) network adapters connected to devices; (j) services on computers; (k) hot fixes on computers; (l) DNS issues (m) recently installed software (n) recently discovered hardware; (o) assets with low disk space, and (p) other items of interest. Reports marked as public may be run by users who are not IT administrators (such as the accounting group, etc) and are accessed through the integrated helpdesk discussed in FIGS. 9 through 11.

The present system allows the IT administrator to control access, through privacy settings 758, to “read-only” access to reports, thereby eliminating the need to run a separate report for different individuals working in the enterprise. For example, a person may desire to know the status of all computers with less than 1 GB RAM from which an enterprise-wide purchase decision may occur to upgrade all such computers. The reporting functions may also allow a view of what computers have a particular software package installed.

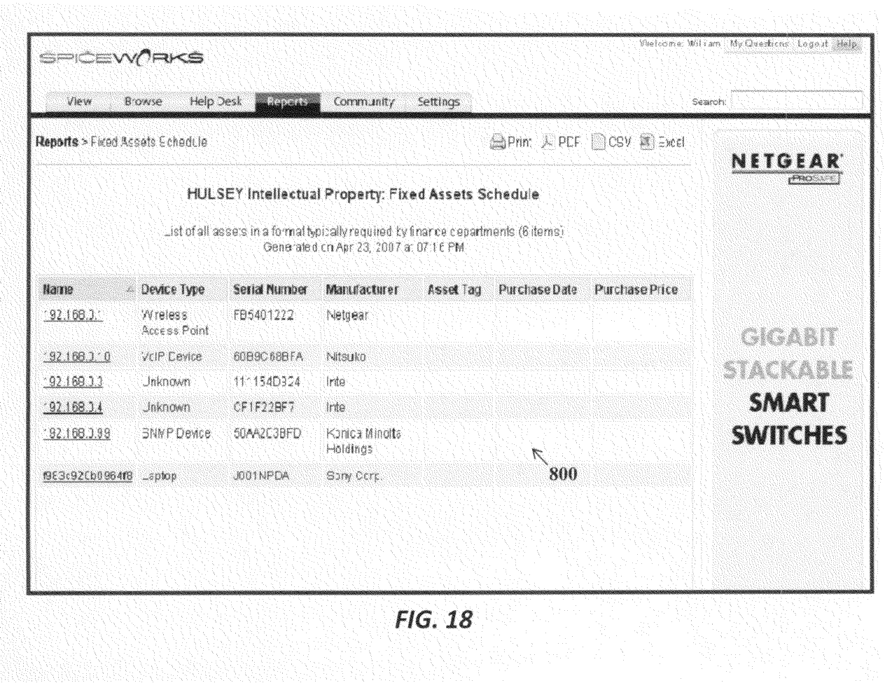

Custom reports may be created and saved for future use. FIG. 18 shows an example of custom report 800. Report 800 shows assets on the network. Further, report 800 presents asset information in a format typically required by most finance departments.

In another example of a custom report, a user may run a report on all open tickets and hone in on important trends and determine which enterprise computers are ready to run Microsoft Vista, for example. Using the community building functions of the present system, an IT administrator may use the reports to collaborate with IT professional elsewhere in the enterprise, as well as in other enterprises around the world.

The presently disclosed method and system help an IT administrator guide individual computer users in the better use of their own information technology resources. Through the use of helpdesk, shown in FIGS. 9 through 11, and reports, shown in FIGS. 13 through 18, an administrator may provide co-workers with access to an individual's own account. The IT administrator may control the level of access a user has to the system, which may vary from full access to read-only access. The IT administrator may assign tickets to different/appropriate people, and solve tricky issues on a local network by asking the 50,000 or more other IT professionals using the disclosed system, including user community disclosed in FIG. 8.

The present disclosure has been made in view of the above objectives to provide a rich set of novel features and functions. To that end, now is disclosed certain aspects of the asset context 16 (FIG. 1) of the present architecture. Using a Web browser desktop-like interface/model, the present disclosure provides integrated asset discovery for hardware and software, as well as manual asset entry. Asset monitoring for hardware and software, including user-definable custom information and notes make the system interactive with the user. Scheduling, automatic updates, and user-definable rules for asset discovery/identification and monitors are also provided. The method and system aid in establishing a community of similarly situated users, including direct feedback functions, the ability to invite a friend, and administration of a console Web-application. Notifications, integrated helpdesk and report, and hosted vs. local deployments are here disclosed as features of the present method and system.

The present disclosure may be loaded fully or partially by adding only the functionality required on the IT administrator's desktop. In the hosted configuration, onsite collection container 510 (FIG. 5) is “local,” but the server and DB are hosted off premise. The onsite collection container is pluggable and provides a bridge to the assets under management. Multiple collection containers are supported for one installation to handle scalability and connectivity constraints due to number of managed assets and their location.

The present disclosure provides a web browser desktop interface (FIGS. 6 through 18) to make the information or analysis needed for a given management or IT related task be a single action or click away from any previous action. This is done through multiple methods and includes up-front analysis of possible items of interest and clean views of the minimum amount of useful information. The application runs outside of the browser, so if the browser is closed, the system will effectively be turned “off” from a user interface perspective, but still actively collect, monitor and analyze computer and network data in the background. While the browser user interface is open/active, it provides current feedback and allows any element to be “clickable” for more detailed data.

The user interface main page continually provides relevant summary data of the computer network or enterprise system. The main page may provide notifications for completed operations (scheduled), alerts that have triggered from a monitor, and basic summary stats of inventory for hardware. New machines may be found as part of scheduled discovery routines. Total machines of various “types” may be grouped or ungrouped and basic summary stats of inventory for software may be collected and generated.

The present disclosure may generate reports (FIGS. 17 and 18) for top installed packages, licenses overused, and recently installed software. Also, pending operations, updated waiting for various software systems, as well as inventory criteria (rules) for hardware and software may be presented. Community breaking news and information may be provided. DNS status flagging possible issues with DNS and active directory status flagging possible issues with active directory may be displayed, as well as assets discovered or under management. The interface may also show hot fixes deployed to assets, services installed/running/stopped on assets, and trouble tickets open/closed/past due/awaiting response. Furthermore, software packages under management may be reported.

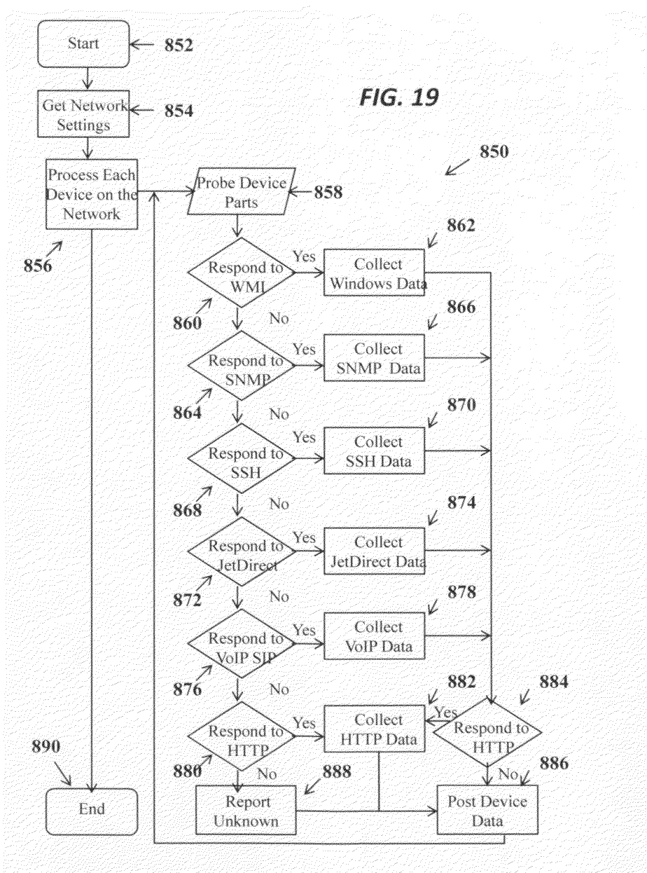

In operation, a user (e.g. an IT administrator) will install software on desktop machine (windows box). The user launches the present system software application or it may be automatically initiated via an installation wizard, prompting the user for their name to register. From there, the application automatically scans the networks attached to desktop machine and locates and collects information about the network's connected devices that they typically manage on an ongoing basis. This process will be discussed in FIG. 19. An aspect of the present disclosure then schedules a job (thread or executable) that begins probing the network across their network for machines, services, etc. In an alternate embodiment of the present disclosure, the probing of the system may be done as a single or multi-pass procedure.

An IT administrator may change and configure options that control the behavior of the present system, but none of this is required for initial operation. These options include manager account passwords (if there are any), adding additional network ranges or names to scan, adding assets manually, and manually added additional information such as building location, asset tag or any other related information that they want to track.

Assets may be automatically grouped by common relevant aspects, including software installed, type of hardware (CPU type/speed, OS, IP/subnet, manufacturer, laptop, desktop, server, . . . ), memory size, disk space, service, and any hot fixes that may have been installed. Also, location, purchase price, purchase date, asset tag or any other attributes may be manually entered by the IT administrator.

The presently disclosed system discovers hardware using an integrated collection container that employs standard remote management access techniques (such as WMI and SNMP) to obtain information from network assets. This collection container is extendable such that future version of the product may add support for additional discovery techniques without changing the application user interface.

A key aspect of the present system's discovery approach is the ability to discover distinct and disparate types of assets. After considering the information truly needed from these disparate asset types for the IT administrator to do their job, the electronically available asset information from these devices and other sources is normalized to be in a consistently useful form. In this way, assets such as Windows computers, Linux computers, Mac OS X computers, printers, routers, switches, VoIP devices etc are discovered and processed by the present system.

During the hardware discovery process, a network prospect is probed to see if it supports standard remote access protocols such as WMI, SNMP, SSH, HTTP, etc. If a viable protocol is supported, it is used to collect information about the asset. This asset information may include, but is not limited to manufacturer, model, network identifier, machine name, asset operating system and kernel versions, CPU, memory, networking (IP and MAC address), BIOS version, serial number, disk usage, management web interface, and remote control interface, for instance. After an asset is discovered, manual fields may optionally be filled in on an ad hoc basis by user and include but are not limited to department, cost, dates, etc. along with basic tracking info that will be customer specific.

The system of the present disclosure integrates automated software discovery, which includes automated discovery of assets that are installable on a computer such as software, services and hot fixes. During the hardware discovery process, if the class of asset supports interrogation of installed assets such as software/hot fixes and/or services, they are automatically collected and automatically associated with this asset and other assets that use similar software/hot fixes/services.

The software discovery process includes making visible certain aspects of whether the software is running, installed, the version number and patch level of the software and any other relevant information about the software. Software assets in typical installations will likely dwarf the hardware assets throughout a network, therefore, in an aspect of the present disclosure summary views are implemented in desktop application.

Summary data may include top installed applications (summary data at the topmost view), top running applications, new applications discovered, data that is visible via drill down via multiple paths. The total number of machines on which software X is installed, and software packages installed across user base. The present system may also flag license keys that are “over used”.

Another aspect of the present disclosure provides for setting a license count indicating the total number of licenses for the particular software. A software compliance report automatically uses this information to show the IT administrator software that is being used without a license or unused licenses. A software compliance alert is automatically generated if this threshold is crossed, and optionally a notification is sent to the IT administrator when this threshold is crossed. Version, hot fixes and/or system or software patches are monitored and acquired (optional for the IT administrator to deploy) and status is displayed in the present system.

The presently disclosed system also provides for monitoring the maintenance of key software assets, such as Microsoft® Operating with patch information, Office® with version information, browser(s) installed w/version information, anti-virus installed w/version info (virus definitions), status, up to date, enabled.

The present system, furthermore, allows for manual asset entry, for assets that are not discovered by the present system discovery process. An IT administrator may manually enter information about these assets. Once in the system, they are treated like other assets. That is, they may have relevant associations linked to them, be reported on, etc.

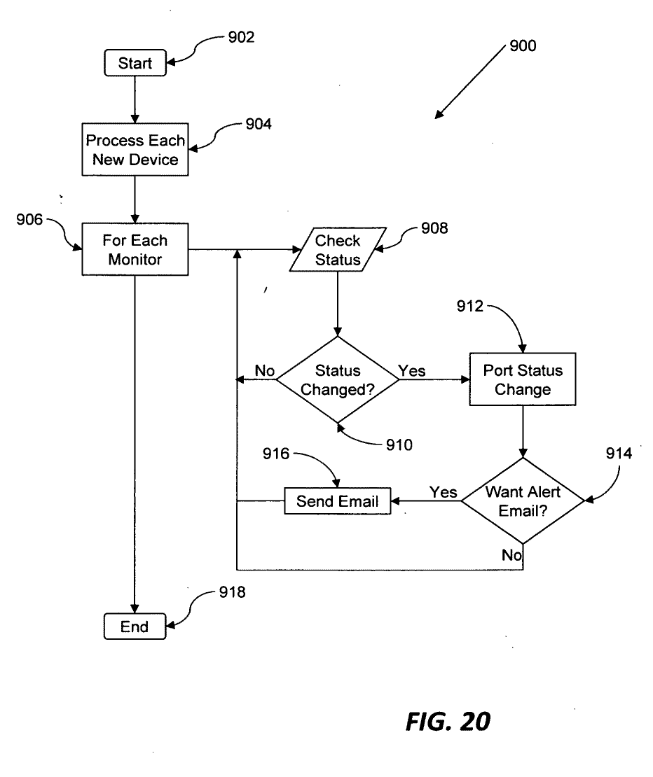

In providing a workflow context for an enterprise IT network, the present system includes a set of hardware and software monitoring features. The process of monitoring hardware and software assets on the network will be discussed further in FIG. 20. Hardware monitoring features of the present system are provided without any additional configuration of the present system. Key aspects of the discovered hardware assets are automatically monitored. These monitors include low disk space, whether an asset is offline, whether printer ink supply level is low, and other workflow context information. Also, initially, without any additional configuration of the present system, key aspects of the discovered software assets (software, hot fixes, patches, services) are automatically monitored. These monitors include detection of known resource consuming software, i.e., WeatherBug® and Google® Desktop®, detection of anti-virus software being out of date and of having more than one anti-virus software suite installed, and detection of license count for a particular piece of software being exceeded.

The present system also accommodates user-definable custom workflow context information. After an asset is discovered, manual fields may optionally be filled in on an ad hoc basis by an IT administrator to include but are not limited to department, cost, dates, etc. along with basic tracking info that will be customer specific. Typically, manually tracked custom information such as this is tracked by the IT administrator in an external document, spreadsheet, or notebook. Allowing the IT administrator to associate it in the present system desktop keeps this information relevantly associated with the proper asset, and organized so that the information they need is always close at hand.

The IT administrator may optionally add additional custom fields that they want to capture, and set a default value for them as well as a type such as currency, number, date, or string. Any custom attribute defined in the system behaves like attributes built into the system. That is, a user may pivot, filter and report on these custom attributes like they were built into the system.

The concept of data pivoting will now be discussed. The disclosed subject matter includes a data pivoting or fast-find function for providing an ability to pivot on data. Data pivoting provides the function of finding more data of a particular type or, alternatively, selecting against a particular type of data i.e., data not like a particular type of data. This is an easily accessible feature from anywhere in the disclosed system and can act/operate on virtually any node in the system. The system makes sure that it knows where the process flow is in a process tree and where a user is likely to try to go next in using the system. This addresses the problem of having an unmanageably long list of options from which to pick based on a cumbersome list of options. In other words, the system provides the ability to discern the meaning and relevance of different data.

A particularly novel aspect of the present disclosure includes with discerning the user view upon the occurrence of a data pivot. This depends on where the user is in the system when a data pivot occurs. If the user is in a tree or limb node of the system, then the user should probably go to a similar view. In such a view, however, the new filtered data will be presented. That is, the same types of things will be presented—just more or less of them. If, on the other hand, the user is on a leaf node, then most likely, they may pop-up a level to a view with more nodes in it. Such a view will assume the result of the pivot provides more elements than one. If the system returns only one element back from the pivot, then the system will provide the user with the same view presently shown, in a leaf or detailed view. The main difference in such an instance is that in one model, the user will “hop” back up the tree. In the other model, the user will move to another leaf node in the system.

Additionally, the disclosed system presents these options to the user in beneficial ways. In some cases the system may need to know that the use desires to view computers with or without X. In other cases, the user may desire to know which computers have different software packages or patches on X. The notion of an advanced version of the pivot enhances the “Browse” view to effectively allow a user to browse around a networked system hierarchy in any direction. A further embodiment provides the user with the advanced choice of entering a browse mode with navigational functions already completed, according to/from where in the data hierarchy the system operation occurs.

Elements that are pivotable may be anywhere in the system and may include a simple easy-to-understand way of identifying the elements as “special,” thereby inviting the user to move their computer screen cursor over to the pivotable element. Once there (e.g., via movement of a mouse) a flyover application may yield a small popup with more details about the pivotable element.

If a pivot is available, the system displays this feature, e.g., by underlining the element. The user may then know that clicking on the element is possible. Once clicked, a small choice list is dropped down. Alternatively, the system may use a small triangle or other symbol (pointing down) to indicate this function. Special pieces of data may be highlighted (e.g., by color) so that folks know that there is something special to do there.

A fly over or hovering over the pivotable item causes a popup menu to appear. The popup menu provides more relevant details about the particular item. There may be many ways to determine associated functions and features using the presently disclosed data pivoting function. As such, the presently claimed invention would include within the scopes of the claims here appending contemplation of such variations.

User definable notes provide a further workflow context feature of the present disclosure. That is, in addition to custom information, after an asset is discovered, notes may be associated with an asset. Typically notes may be kept on a notebook, spreadsheet, or text document disconnected from the assets, so this helps keep an IT administrator organized.

Preferably, the discovery functions of the present system may be enabled and scheduled initially to run twice a day. An IT administrator may modify this schedule to run at different times of the day and changes the time between scans. No changes are required for present system to operate correctly. One embodiment of the present system provides for self-updating and a user may restart to obtain the latest version. While not required for proper operations, an IT administrator may augment the rules used to discover and identify an asset. This ability is remembered by the system and used during future discovery passes. The user may specify which TCP/IP ports to look for known active service protocols such as WMI, HTTP, SSH, SNMP, etc.

The ability to use the network MAC address owner as a precursor to determine device type (e.g., MAC address owned by Cisco implies the device is a Cisco device). The present disclosure provides the ability for a user to manually classify an asset and have that manual classification remembered by the system, in the event that the device is found on later scans.

The present system also provides for views based on groups. Initially, the system may provide well-known grouping of asset classes, so that an IT administrator may quickly look at data across an asset class such as workstations (includes laptop and desktop assets), servers, networking assets (includes routers, switches, hubs), network printers, Voice over IP (VOIP) devices, etc. Additional classes may be defined if desired by the IT administrator in the admin console. The present system and method also enable users to pivot on data from any view of the system to locate other similar or dissimilar information belonging to other assets in the system or to drill down further into the data of interest without having to access a separate and distinct functionality. Available pivots may be highlighted via underlying, color code etc. If a user clicks on a pivot, the default view may show other similar assets that match that pivot.

If the user's cursor floats over a pivot, options from a drop down or similar menu may include vertical, advanced find, and horizontal. Vertical searches for string values may include find all assets with the same value and find all assets with a different value. For numeric values, searches may be to find all assets with this value greater than or equal to the value for this item and find all assets with this value that is less than the value for this item.

The advanced find search initiates browser view. Horizontal search allows use of known information for an asset or groups of assets to find information outside of the network. These operations may not require the user to specify this asset context information. This results in timesavings by the IT administrator by automatically selecting relevant information for them. The relevant information may include support information from the manufacturer and model of a given asset is one click away by directing the user to the manufacturers support websites. Depending on the asset type, additional information may be included, such as the service tag of the asset or the management OID. This may aid the user to obtain support that is more relevant quickly.

Other community information may include product review (FIG. 7). Product reviews may be found through matching the manufacturer and model and shown to the user. These reviews may be independent third party reviews, or reviews given by the community below. Also, community advice and questions/answers from a given asset or class of assets may be obtained in this manner. A user may ask for advice from or pose a question to the community (other users of the present application) and the asset context will automatically be included in the question. Other users in the community with a similar context will be shown those questions that pertain to their environment. Such questions and answers will automatically be shown to other users of the system when they are in a similar context.

Workflow context information such as this may include recommendations of how many other environments look like a particular IT administrator's environment. Information on what is different among different enterprise networks, as well as similarities may be discussed using the present system with a broad array of community member. Aspects of the present disclosure may include inviting a friend via an email (e.g., a preformed or “pre-canned” email), asking a question to the community, as well as pull downs or clicks that allow for a “view” into the community for a particular operation.

The present system allows a user to invite a friend or obtain direct feedback. Aspects of the present disclosure include the ability to invite a friend. The user enters a friend's email address, and an email is sent to that address inviting them to use present system as well.

Direct feedback may include built-in forums so that users may provide direct feedback for feature and issues with the present system application. Other present system community users may vote on suggested features, and then future releases of present system includes these features if possible.

The system of the present disclosure further includes an administrator console web application, which may include a browser type functionality that is easy-to-use and integrated into the system as a whole. The user interface allows the IT manager to view relevant information from a particular context or is just one-click away.

The present system also provides a robust set of features supporting the event context aspects of the overall architecture. Monitors inspect specific aspects of the data and state of the managed assets in the present system. A monitor may generate an alert that the IT administrator will see on web interface. Alerts may be associated with any entity in the present system such as an asset, ticket, hot fix, or piece of software. They are then displayed in the proper context of the present system and may be used quickly to drill down to the information needed. For example, an alert that computer X is low on disk space, when viewed, takes you to asset information for that computer. Here you may see the current disk usage and a history of that usage, the model and size of the disk, and relevant community discussions that might talk about how to upgrade that disk or other strategies to fix the low disk space condition.

Another example, discussed previously, is that a piece of software might be used by too many computers. The software compliance alert when drilled into would show the IT administrator all of the computers using the software in question, and then the IT administrator could remove it from a machine that should not have the software, buy additional license to be in compliance, or possibly read relevant community discussions on this software and alternatives.

Notifications for alerts generated by the present system may optionally be sent to an IT administrator's email address or other group email address. These notifications have the information on why the alert was sent and URLs back into the present system so that the IT administrator may quickly obtain to the needed relevant information to address the alert.

The present system supports hosting at a server site and allows complete or partial implementation on the user system. Additionally, various functions may be implemented at various levels of the users hierarchy and only provide information and functionality for those system down-stream of the particular aspect implemented.

FIG. 19 depicts schematic flow diagram 850 of integrated asset and configuration discovery system 20 of FIG. 1. In the scanning and discovery process, method steps and parameters are initiated and launched as represent by start 852. Control then passes to obtain network settings step 854. At step 854, integrated asset and configuration and discovery system 20 (FIG. 1) automatically determines network settings, but information may also be manually provided by an IT administrator. For example, an IT administrator could supply information, such as off-site IP addresses, domain names, etc., that is part of the system and needs to be aggregated by central services engine 506 (FIG. 5). Application engine 508 makes this information accessible. This initial information may also include any required security passwords or logins required to access some or all of the systems on the network.

Returning to FIG. 19, at step 854 the network settings are obtained as well as checking of the domain name and the DNS lookup in both directions. Any DNS errors found are aggregated into a top level view so that they later may be corrected by the IT administrator if desired.

An identifier for a computer or device on a TCP/IP network, networks using the TCP/IP protocol route messages based on the IP address of the destination. The format of an IP address is a 32-bit numeric address written as four numbers separated by periods. Each number may be zero to 255. For example, 2.160.10.240 could be an IP address.

Within an isolated network, IP addresses may be assigned at random as long as each one is unique. However, connecting a private network to the Internet requires using registered IP addresses (called Internet addresses) as specified by networking standards. The four numbers in an IP address are used in different ways to identify a particular network and a host on that network. Four regional Internet registries—ARIN, RIPE NCC, LACNIC and APNIC —assign Internet addresses from the following three classes. Class A —supports 16 million hosts on each of 126 networks; Class B —supports 65,000 hosts on each of 16,000 networks; and Class C —supports 254 hosts on each of 2 million networks.

In a 32-bit IP address, the number of bits used to identify the network and the host vary according to the network class of the address. In a Class C network, the first 3 bits, or the high-order bits, are always “110.” The next 21 bits are used to define the Class C network, and the final eight bits are used to identify the host. The IP address is represented in dotted decimal notation of four 8-bit fields, or octets, that have been converted from binary to decimal numbers.

The number of valid networks and hosts available is always 2^{N} (where N equals the number of bits used) minus 2 (one for the all zeros address and one for the all ones address). Thus, for a class C address wherein 8 bits are available for hosts, the number of hosts is 2⁸−2, or 256−2, which is 254.

Future versions of this software will support Ipv6 which allows for a much greater range of IP addresses. At step 854, the system of the present disclosure determines how wide the network is and allocates search protocols based on this measure. For instance, in a Class C network there are 254 potential hosts. Each device has or should have a unique IP address or sub-mask address. If an IP address or DNS name is provided by the IT administrator, a DNS lookup takes place. The present disclosure confirms the DNS name and IP address associated with it and assures that the IP address defaults to the DNS name and vice-versa. If an IP address or DNS name is not provided, during step 856 the search engine will set the range based on how wide the network is (obtained at step 854) and ping each element to see if it responds. If an element does respond, it is probed to see if it is listed on one of the ports or is a unique name or IP address device. Having “ping”-ed an element and it responds, control then passes to step 858 where the element is probed.

Although the following steps are listed in a logical and efficient manner for probing elements on a network, other groupings or searching hierarchies may be employed or plugged in later and not depart from the scope of the present disclosure.

At step 860, the device is probed to see if it responds to WMI. Windows Management Instrumentation (WMI) is a set of extensions to the Windows Management Instrumentation that provides an operating system interface through which instrumented components may provide information and notification. If the device is identified as a WMI device, data is collected at step 862 and control passes to step 884 where a determination as to whether the device responds to HTTP is made (i.e., has a web server interface). Hypertext Transfer Protocol (HTTP) is a method used to transfer or convey information on the World Wide Web. If the device is found to be a WMI at step 860, the remaining steps 864 through 880 are skipped, since by default the device will not respond to any of the other protocols.

At step 864, the device is probed to see if it responds to SNMP. The simple network management protocol (SNMP) forms part of the internet protocol suite as defined by the Internet Engineering Task Force (IETF). SNMP is used by network management systems to monitor network-attached devices for conditions that warrant administrative attention. It consists of a set of standards for network management, including an application layer protocol, a database schema, and a set of data objects. If at step 864 the device responds, it is identified as a SNMP device and data is collected at step 866. Control passes to step 884 where a determination as to whether the device responds to HTTP is made. The remaining steps 868-880 are skipped.

At step 868 if the device responds, it is identified as a SSH device, data is collected at step 870 and control passes to step 884 where a determination as to whether the device responds to HTTP is made. Steps 872-880 are skipped. Secure Shell or SSH is a set of standards and an associated network protocol that allows establishing a secure channel between a local and a remote computer. It uses public-key cryptography to authenticate the remote computer and (optionally) to allow the remote computer to authenticate the user. Shell commands are then used to obtain the needed information from the asset.

At step 872 if the device responds, it is identified as a JetDirect device, data is collected at step 874 and control passes to step 884 where a determination as to whether the device responds to HTTP is made. Steps 876-880 are skipped. JetDirect is the name of a technology sold by Hewlett-Packard that allows computer printers to be directly attached to a Local Area Network. The most common communication uses TCP/IP port 9100.

At step 876 if the device responds, it is identified as a VoIP SIP, data is collected at step 878 and control passes to step 884 where a determination as to whether the device responds to HTTP is made. Voice over Internet Protocol, also called VoIP, IP Telephony, Internet telephony, Broadband telephony, Broadband Phone and Voice over Broadband is the routing of voice conversations over the Internet or through any other IP-based network.

At step 880 if the device responds, it is identified as an HTTP device and data is collected at step 882. If no response is received, control then passes to step 888 wherein an exception report or alert is generated and forwarded to the IT administrator providing the directions as to how to handle these occurrences.

The reason the device failed to respond or did not respond fully, after being identified as being on the system could be numerous. In this instance the port is identified as being open but is identified as not showing anything on it. This could occur for various reasons, such as the user may not have the security clearance to access the system/device in question or a separate login is required that was not provided. The device may be behind a firewall or other device such as a hub that will not respond.

Once the data is collected control then passes to step 886 wherein the data collect is posted with each device found on the network. Process steps 856 through 888 may be repeated again at a later time to discover new network devices, but a report will only be generated for devices previously identified if the device configuration has changed. This information is stored on the system so that a history of the device may be created and used to compare with itself or other devices similarly configured and equipped.

Trouble shooting devices on the network may be made easier through a snapshot of the device history created through flow diagram 850. Flow diagram 850 also provides the IT administrator the functionality and ability to ensure that each user on the system is appropriately configured with the software, hardware, peripheral access and etc. that their security level or access level requires or allows. Therefore, if a system BIOS or other parameters are changed and a problem occurs, the IT administrator may utilize this tool to identify the change in the systems configuration and take appropriate measures to resolve it.

FIG. 20 depicts schematic diagram 900 of a watcher or monitoring engine of an aspect of the present disclosure. This aspect of the present disclosure monitors identified devices on the system at periodic times. It mainly looks for devices that switch states between online and offline and sends flags of these events for the IT administrator as discussed below. For large organizations, the monitoring engine may segment the total number of devices and monitor each segment in a rotating fashion as not to over tax the operating systems. Although, this should not be a concern, since the data gathered and transmitted is on the order of 10s of K and require very little system resources to run. Therefore, in most instances, the user will not even be aware of the programming scanning operation. Alternately, the monitoring engine may be directed to only run when system resources are below a certain level (i.e. below 60% or below 80%) to ensure that productivity is not hampered by the scanning and transmitting of data process.

Returning now to FIG. 20, the monitoring or watcher flow engine is initiated with the parameters set by the IT administrator at step 902. Control then passes to step 904 where each known device is processed. Control then passes to step 906 for each monitor where a check status request is initiated at step 908. If the result of the check status is a positive, i.e., the status has changed, the status change is posted at step 912. If the check status request is a negative, i.e., a no result, the process terminates.

Once the change is posted at step 912, control then passes to step 914, where a determination is made, in compliance with the IT administrator set up instructions, to send an email or other type alert, such as creating an exception report, or log. If the determination at step 914 is a no, then the process terminates, although the data is still stored with the device showing the time of the last scan and its results. This data may remain indefinitely on the system or be periodically culled using a FIFO method over a set time period. If the instructions are affirmative at step 914 to send an email, control passes to step 916 where an email or some other type alert is direct to the party or parties designated by the IT administrator.

The watcher flow or monitoring engine continually performs the various described functions at the period intervals set up for the monitoring process until the process is terminated or altered by the IT administrator.

It will be apparent to those skilled in the art that various modifications and variations may be made in the above disclosure and aspects of the disclosure without departing from the scope or intent of the disclosure. Other embodiments of the disclosure will be apparent to those skilled in the art from consideration of the specification and practice of the disclosure disclosed herein. It is intended that the specification and examples be considered as exemplary only.

What is claimed is:

1. A method for resolving issues associated with a local network of information technology (IT) devices having a host computer, comprising the steps of:
initiating an inventory of a plurality of IT devices associated with a local IT network;
generating a profile associated with at least a subset of IT devices from said plurality of IT devices, said profile comprising device information regarding said subset of IT devices;
determining the operational status of said subset of IT devices;
monitoring said operational status of said subset of IT devices;
generating a ticket comprising information regarding at least one of said subset of IT devices for resolving an issue associate with said at least one of said subset of IT devices, said ticket generated via an automatic electronic communication means;
automatically associating said ticket with one of said profiles, said one of said profiles associated with at least one of said subset of IT devices; and
presenting said ticket to a host computer for further action.

2. The method of claim 1, wherein said inventory initiating step further comprises the step of initiating an inventory of essentially all Media Access Control (MAC) addresses for computers associated with said local IT network.

3. The method of claim 1, wherein said inventory initiating step further comprises the step of initiating an inventory of essentially all servers, routers, printers and other IP-based devices, software packages, services, hot fixes, and patches associated said local IT network.

4. The method of claim 1, wherein said determining the operational status step further comprises the step of determining the status of essentially all software programs, servers, routers, printers and other IP-based devices, software packages, services, hot fixes, and patches associated with said local IT network.

5. The method of claim 2, wherein said determining the operational status step further comprises sorting essentially all cables and ports associated with said local IT network by said MAC addresses.

6. The method of claim 1, wherein said generating step further comprises generating said ticket via an e-mail or web portal.

7. The method of claim 1, further comprising the step of notifying a user once said issue has been resolved via an e-mail notification.

8. The method of claim 1, further comprising the step of allowing a user to check the status of said ticket.

9. The method of claim 1, wherein said generating ticket step further comprises generating a ticket consisting essentially of a work order ticket, purchase order ticket, or resource order ticket.

10. A computer readable medium encoded with a program code for resolving issues associated with a local network of information technology (IT) devices having a host computer, said program comprising instructions for:
initiating an inventory of a plurality of IT devices associated with a local IT network;
generating a profile associated with at least a subset of IT devices from said plurality of IT devices, said profile comprising device information regarding said subset of IT devices;
determining the operational status of said subset of IT devices;
monitoring said operational status of said subset of IT devices;
generating a ticket comprising information regarding at least one of said subset of IT devices for resolving an issue associate with said at least one of said subset of IT devices, said ticket generated via an automatic electronic communication means;
automatically associating said ticket with one of said profiles, said one of said profiles associated with at least one of said subset of IT devices; and
presenting said ticket to a host computer for further action.

11. The medium of claim 10, wherein said medium comprises a program, said program further comprising instructions for initiating an inventory of essentially all Media Access Control (MAC) addresses for computers associated with said local IT network.

12. The medium of claim 10, wherein said medium comprises a program, said program further comprising instructions for initiating an inventory of essentially all servers, routers, printers and other IP-based devices, software packages, services, hot fixes, and patches associated said local IT network.

13. The medium of claim 10, wherein said medium comprises a program, said program further comprising instructions for determining the operational status of essentially all software programs, servers, routers, printers and other IP-based devices, software packages, services, hot fixes, and patches associated with said local IT network.

14. The medium of claim 11, wherein said medium comprises a program, said program further comprising instructions for sorting essentially all cables and ports associated with said local IT network by said MAC addresses.

15. The medium of claim 10, wherein said medium comprises a program, said program further comprising instructions for generating said ticket via an e-mail or web portal.

16. The medium of claim 10, wherein said medium comprises a program, said program further comprising instructions for notifying a user once said issue has been resolved via an e-mail notification.

17. The medium of claim 10, wherein said medium comprises a program, said program further comprising instructions for allowing a user to check the status of said ticket.

18. The medium of claim 10, wherein said medium comprises a program, said program further comprising instructions for generating a ticket consisting essentially of a work order ticket, purchase order ticket, or resource order ticket.

19. A system for resolving issues associated with a local network of information technology devices having a host computer, said system comprising:
a host computer for initiating an inventory of a plurality of IT devices associated with a local IT network;
said host computer for generating a profile associated with at least a subset of IT devices from said plurality of IT devices, said profile comprising device information regarding said subset of IT devices;
said host computer for determining the operational status of said subset of IT devices;
said host computer for monitoring said operational status of said subset of IT devices;
an IT device for generating a ticket comprising information regarding at least one of said subset of IT devices for resolving an issue associate with said at least one of said subset of IT devices, said ticket generated via an automatic electronic communication means;
a host computer for automatically associating said ticket with one of said profiles, said one of said profiles associated with at least one of said subset of IT devices; and
a computer readable storage medium for presenting said ticket to a host computer for further action.

20. The system of claim 19, wherein said host computer further comprises a computer readable storage medium having instructions for initiating an inventory of essentially all Media Access Control (MAC) addresses for computers associated with said local network.

21. A method for resolving issues associated with a local network of information technology (IT) devices having a host computer, comprising the steps of:
initiating an inventory of an IT device associated with a local IT network;
generating a profile associated with said IT device, said profile comprising device information regarding said IT device;
determining the operational status of said IT device;
monitoring said operational status of said IT devices;
generating a ticket comprising information regarding said IT device for resolving an issue associated with said IT device, said ticket generated vie an automatic electronic communications means;
automatically associating said ticket with said profile;
presenting said ticket to a host computer for further action.
